(19) United States
(12) Patent Application Publication
(10) Pub. No.: US 2015/0060757 A1
(43) Pub. Date: Mar. 5, 2015

(54) FIELD EMISSION DEVICES AND METHODS OF MANUFACTURING GATE ELECTRODES THEREOF

(71) Applicant: Samsung Electronics Co., Ltd., Suwon-Si (KR)

(72) Inventors: Dong-gu LEE, Gumi-si (KR); Shang-hyeun PARK, Yongin-si (KR); Yong-chul KIM, Seoul (KR); Chang-soo LEE, Seoul (KR); Do-yoon KIM, Hwaseong-si (KR)

(73) Assignee: KUMOH NATIONAL INSTITUTE OF TECHNOLOGY, Gumi-si (KR)

(21) Appl. No.: 14/471,713

(22) Filed: Aug. 28, 2014

(30) Foreign Application Priority Data
Sep. 2, 2013 (KR) 10-2013-0105097

(51) Int. Cl. H01J 1/308; H01J 9/02; H01J 1/304

(52) U.S. Cl. CPC H01J 1/308; H01J 1/3044; H01J 9/025; H01J 2201/30415; H01J 2201/30453
USPC 257/10; 438/20

(57) ABSTRACT

A field emission device may comprise: an emitter comprising a cathode electrode and an electron emission source supported by the cathode electrode; an insulating spacer around the emitter, the insulating spacer forming an opening that is a path of electrons emitted from the electron emission source; and/or a gate electrode comprising a graphene sheet covering the opening. A method of manufacturing a gate electrode may comprise: forming a graphene thin film on one surface of a conductive film; forming a mask layer having an etching opening on another surface of the conductive film, wherein the etching opening exposes a portion of the conductive film; partially removing the conductive film through the etching opening to partially expose the graphene thin film; and/or removing the mask layer.

### CROSS-REFERENCE TO RELATED APPLICATION(S)

This application claims priority from Korean Patent Application No. 10-2013-0105097, filed on Sep. 2, 2013, in the Korean Intellectual Property Office (KIPO), the entire contents of which are incorporated herein by reference.

### BACKGROUND

1. Field

Some example embodiments may relate to field emission devices and/or methods of manufacturing gate electrodes of field emission devices.

2. Description of Related Art

Electron emission is the phenomenon in which electrons in a solid receive from the outside energy equal to or greater than their work function and thus leave the solid. The energy may be provided in various forms, such as heat, light, electric field, and the like. Field emission devices that emit cold electrons from a conductor via a field emission effect, that is, by applying an electric field to the conductor, are used in various fields. For example, a field emission device having a cathode electrode and a gate electrode is used in an X-ray generator, a field emission display, a back light unit, and the like, which employ a triode structure.

In relation to such field emission devices, various studies have been conducted to more efficiently generate a large number of electrons under a relatively low gate voltage.

### SUMMARY

Some example embodiments may provide field emission devices for efficiently generating large numbers of electrons under relatively low gate voltages and/or methods of manufacturing gate electrodes of the field emission devices.

Some example embodiments may provide field emission devices for improving the traveling straightness of electrons emitted from emitters and/or methods of manufacturing gate electrodes of the field emission devices.

Some example embodiments may provide field emission devices for reducing leakage currents flowing through gate electrodes and/or methods of manufacturing gate electrodes of the field emission devices.

In some example embodiments, a field emission device may comprise: an emitter comprising a cathode electrode and an electron emission source supported by the cathode electrode; an insulating spacer around the emitter, the insulating spacer forming an opening that is a path of electrons emitted from the electron emission source; and/or a gate electrode comprising a graphene sheet covering the opening.

In some example embodiments, the gate electrode may further comprise an electrode unit around the opening. The graphene sheet may be connected to the electrode unit.

In some example embodiments, the graphene sheet may be a graphene single-layered film or a graphene multi-layered film.

In some example embodiments, a field emission device may comprise: an emitter comprising a cathode electrode and an electron emission source supported by the cathode electrode; an insulating spacer around the emitter; and/or a gate electrode, supported by the insulating spacer, comprising an electrode unit that defines an opening that is a discharge path of electrons emitted from the emitter, and a tunneling member that covers the opening and passes the electrons therethrough according to a tunneling effect.

In some example embodiments, the tunneling member may comprise a graphene-continuous film.

In some example embodiments, the graphene-continuous film may be connected to the electrode unit.

In some example embodiments, the graphene-continuous film may be a graphene single-layered film or a graphene multi-layered film.

In some example embodiments, the electron emission source may comprise a plurality of graphene thin films vertically supported in the cathode electrode.

In some example embodiments, each of the plurality of graphene thin films may comprise: a first portion buried in the cathode electrode; and/or a second portion that extends from the first portion and is exposed from the cathode electrode.

In some example embodiments, the cathode electrode may have a pointed shape toward the opening. The plurality of graphene thin films may be in a pointed structure toward the opening.

In some example embodiments, each of the plurality of graphene thin films may be a graphene single-layered film or a graphene multi-layered film.

In some example embodiments, a method of manufacturing a gate electrode may comprise: forming a graphene thin film on one surface of a conductive film; forming a mask layer having an etching opening on another surface of the conductive film, wherein the etching opening exposes a portion of the conductive film; partially removing the conductive film through the etching opening to partially expose the graphene thin film; and/or removing the mask layer.

In some example embodiments, the graphene thin film may be a graphene-continuous film.

In some example embodiments, the graphene thin film may be a graphene single-layered film.

In some example embodiments, the graphene thin film may be a graphene multi-layered film.

### BRIEF DESCRIPTION OF THE DRAWINGS

The above and/or other aspects and advantages will become more apparent and more readily appreciated from the following detailed description of example embodiments, taken in conjunction with the accompanying drawings, in which:

FIG. 1 is a cross-sectional view illustrating a field emission device according to some example embodiments;

FIG. 2 is a diagram showing emission of electrons when a gate electrode includes only an electrode unit without including a graphene sheet;

FIG. 3 is a diagram showing emission of electrons from the field emission device illustrated in FIG. 1;

FIG. 4A is a diagram showing a graphene thin film formed on one surface of a conductive film;

FIG. 4B is a diagram showing a mask layer formed on another surface of a conductive film, the mask layer having an etching opening;

FIG. 4C is a diagram showing a conductive film partially removed through an etching opening;

FIG. 4D is a diagram showing a graphene sheet obtained by removing a mask layer;

FIG. 5 is a cross-sectional view of an emitter illustrated in FIG. 1, according to some example embodiments;

FIG. 6 is a plan view of an emitter illustrated in FIG. 1, according to some example embodiments;

FIG. 7 is a cross-sectional view of an emitter illustrated in FIG. 1, according to some example embodiments;

FIG. 8A is a diagram illustrating a graphene sheet including a graphene thin film;

FIG. 8B is a diagram illustrating a graphene stack structure in which a graphene thin film and a conductive film are repeatedly stacked;

FIG. 8C is a diagram illustrating a process of molding a graphene stack structure and a conductive powder;

FIG. 8D is a diagram illustrating a sintered structure formed by sintering a molded structure including a plurality of graphene thin films stacked apart from each other in a conductor;

FIG. 8E is a diagram illustrating a cut structure formed by cutting a sintered structure to an appropriate size;

FIG. 8F is a diagram illustrating a portion of a conductor removed from a sintered structure or a cut structure in length direction of the graphene thin films to expose the graphene thin films;

FIG. 8G is a perspective view of the emitter of FIG. 2, manufactured by processes illustrated in FIGS. 8A through 8F;

FIG. 8H is a diagram illustrating the sintered structure of FIG. 8D or the cut structure of FIG. 8E slantingly cut with respect to the length direction of graphene thin films to form a spire-shaped structure;

FIG. 8I is a diagram illustrating a portion of a conductor removed from a spire-shaped structure in length direction of graphene thin films to expose the graphene thin films;

FIG. 8J is a perspective view of the emitter of FIG. 7, manufactured by processes illustrated in FIGS. 8A through 8E, 8G, and 8H;

FIG. 9 is a schematic block diagram of an X-ray imaging device including the field emission device illustrated in FIG. 1; and

FIG. 10 is a diagram illustrating a back light device (display device) including the field emission device illustrated in FIG. 1.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Example embodiments may be described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will typically have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature, their shapes are not intended to illustrate the actual shape of a region of a device, and their shapes are not intended to limit the scope of the example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

FIG. 1 is a cross-sectional view illustrating a field emission device 1 according to some example embodiments.

Referring to FIG. 1, the field emission device 1 includes an emitter 30 and a gate electrode 40. The emitter 30 includes a cathode electrode 10 and an electron emission source 20 supported by the cathode electrode 10. The emitter 30 is disposed on a substrate 110. An insulating spacer 120 is disposed to surround the emitter 30 on the substrate 110. A body 100, which has a cavity 130 and an opening 131 allowing the cavity 130 to communicate with the outside, is formed by the substrate 110 and the insulating spacer 120. Electrons emitted from the emitter 30 are discharged to the outside through the opening 131. The gate electrode 40 is supported by the insulating spacer 120. The gate electrode 40 includes an electrode unit 41 formed of a conductor and a graphene sheet 42 (tunneling member) that is connected to the electrode unit 41 and covers the opening 131. The electrode unit 41 is supported by the insulating spacer 120. The electrode unit 41 is formed around the opening 131. The electrode unit 41 may be formed along an edge of the opening 131. Also, the electrode unit 41 may have a form extending from the edge of the opening 131 to the inside of the opening 131. In this case, it may be understood that the opening 131 is defined by the electrode unit 41.

The emitter 30 is disposed in the cavity 130. The emitter 30 is disposed on the substrate 110 so that the electron emission source 20 is opposite the opening 131. The gate electrode 40 is disposed on the upper surface of the insulating spacer 120 (i.e., at an end of the insulating spacer 120 at the side of the opening 131) and, thus, has a form surrounding the opening 131. The opening 131 functions as an electron discharge path. The shape of the opening 131 is not limited thereto, and may be a circle, a tetragon, a pentagon, a hexagon, etc.

Due to the configuration described above, when a voltage is applied to the gate electrode 40, a strong electric field is applied to the electron emission source 20 and, thus, electrons are emitted from the electron emission source 20 due to an energy that is provided by the electric field. The electrons pass through the opening 131 and move toward an anode electrode 2 illustrated in FIG. 1. By employing the anode electrode 2 formed of a metal, such as molybdenum (Mo), silver (Ag), tungsten (W), chromium (Cr), iron (Fe), cobalt (Co), copper (Cu), or the like, or a metal alloy, an X-ray generator for emitting X-rays may be implemented. In addition, by arranging a plurality of field emission devices in an array form, an X-ray apparatus capable of generating a three-dimensional image (e.g., a digital breast tomo-synthesis) for diagnosing breast cancer may be implemented. Moreover, the field emission device may be applied to various apparatuses, such as a display, a lighting apparatus, and the like.

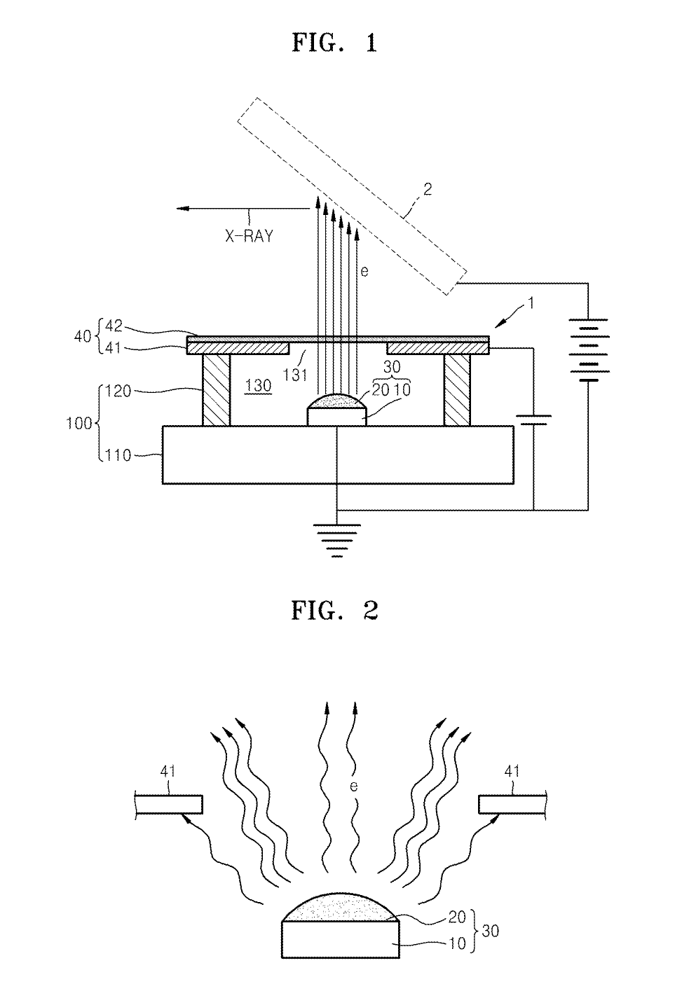

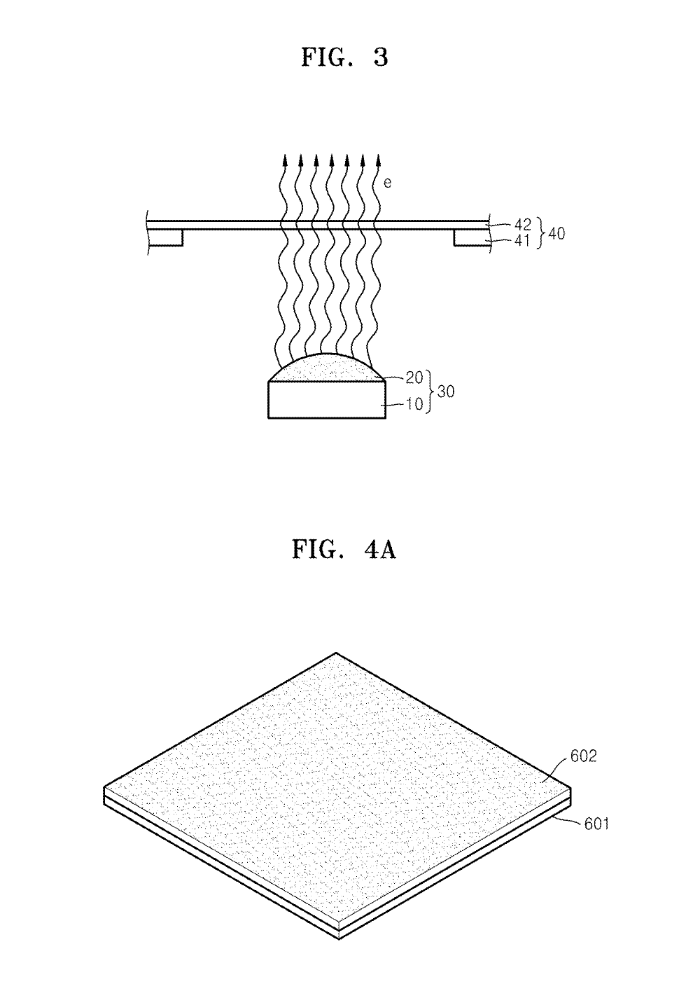

FIG. 2 is a diagram showing emission of electrons when the gate electrode 40 includes only the electrode unit 41 without including the graphene sheet 42, that is, when the opening 131 is opened. When a gate voltage is applied to the gate electrode 40, a relatively strong electric field is applied to a portion of the electron emission source 20 which is close to the gate electrode 40, rather than a portion of the electron emission source 20 which is far from the gate electrode 40. In this case, an electron emission density of the portion of the electron emission source 20 which is close to the gate electrode 40 is relatively large and, thus, an electron emission density of the electron emission source 20 may be non-uniform. In addition, electrons “e” emitted from the portion of the electron emission source 20 which is close to the gate electrode 40 may not be discharged through the opening 131 and leak through the gate electrode 40 as a leakage current. Thus, the electron emission efficiency of the electron emission source 30 may be adversely affected.

According to the field emission device 1 according to the current embodiment, the opening 131 is covered by the graphene sheet 42 connected to the electrode unit 41. When a gate voltage is applied to the electrode unit 41, the gate voltage is applied also to the graphene sheet 42. Thus, a distance between the electron emission source 20 and the gate electrode 40 is almost uniform and, thus, an almost uniform electric field is applied to all portions of the electron emission source 20. As a result, electrons may be emitted with an almost uniform density at all portions of the electron emission source 20.

The graphene sheet 42 is a graphene-continuous film. The graphene-continuous film includes graphene particles continuously arranged, and has a structure opposite to a graphene-discontinuous film in which a space is intentionally formed between graphene particles. The graphene sheet 42 may be a graphene single-layered film or a graphene multi-layered film including a plurality of graphene layers. The graphene sheet 42 is an ultra-thin film having a thickness in the range of only one atom thickness, which is a few angstroms, to several times through hundred times of one atom thickness and, thus, electrons emitted from the emitter 30 pass through the graphene sheet 42 by tunneling. Thus, the leakage current that leaks through the electrode unit 41 is reduced, thereby improving the field emission efficiency.

The electrons emitted from the emitter 30 advance almost vertically toward the graphene sheet 42 to which the gate voltage was applied, and thus pass through the opening 131 almost vertically. Thus, the traveling straightness of the electrons may be improved.

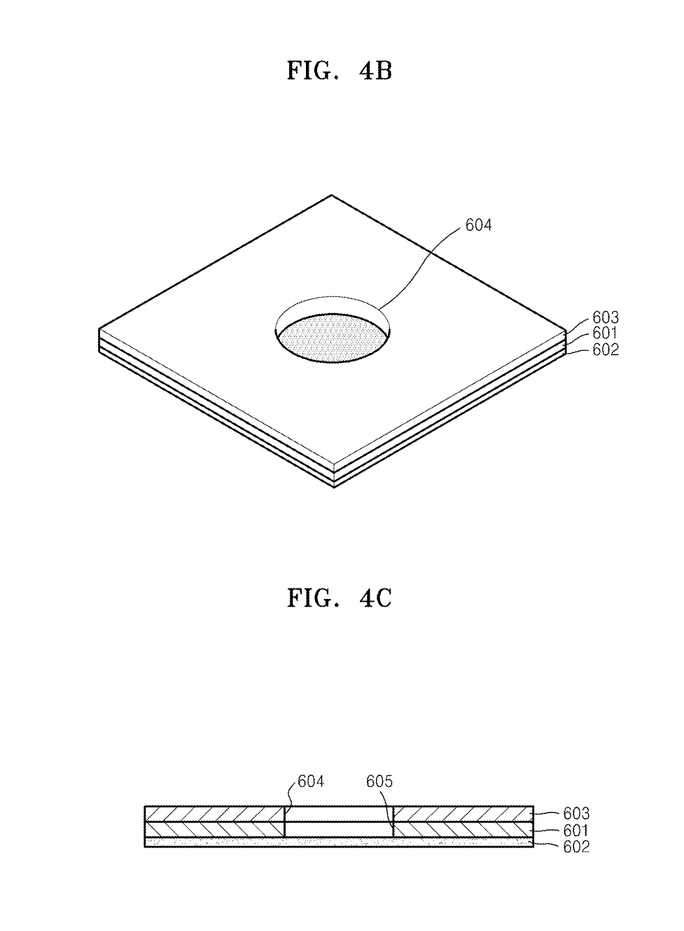

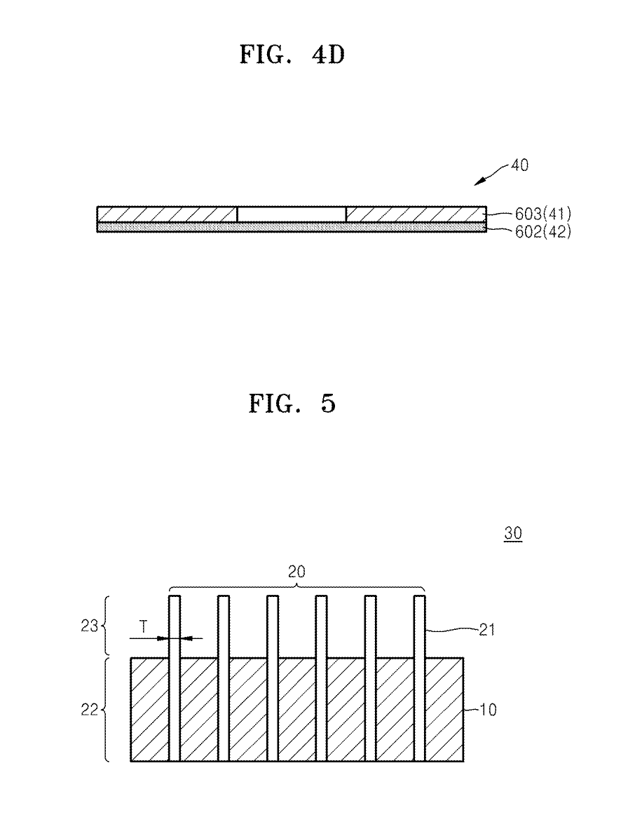

Below, a method of manufacturing the gate electrode 40 according to some example embodiments is described with reference to FIGS. 4A through 4D.

[Formation of Graphene Thin Film]

As illustrated in FIG. 4A, a graphene thin film 602 is formed on a surface of a conductive film 601. A method of forming the graphene thin film 602 is not limited to a specific method, and may be any one of various known methods. For example, the graphene thin film 602 may be formed by growing a graphene atom layer on the conductive film 601 through chemical vapor deposition (CVD). When the CVD is used, a large amount of graphene may be formed in a relatively short time. A metal thin film formed of metal may be used as the conductive film 601. Examples of the metal include copper, nickel, cobalt, iron, platinum, gold, aluminum, chromium, magnesium, manganese, molybdenum, rhodium, silicon, tantalum, titanium, tungsten, etc. Hydrogen and hydrocarbon (CₓH_{y}) may be used as gas (hereinafter, referred to as “growth gas”) that is used to grow the graphene atom layer. The hydrocarbon (CₓH_{y}) may include methane, ethane, ethylene, ethanol, acetylene, propane, propylene, butane, butadiene, pentane, pentene, cyclopentadiene, hexane, cyclohexane, benzene, toluene, or the like. The conductive film 601 and the growth gas are supplied into a reactor (not shown) to treat the conductive film 601 by heating. A heat treatment temperature may be, for example, in the range of about 800° C. to about 1000° C., and a heat treatment time may be, for example, in the range of about 30 minutes to about 2 hours.

The number of graphene layers that are grown may be adjusted by various methods. An example of these various methods is a method of controlling the type or thickness of the conductive film 601. For example, when a copper thin film is used as the conductive film 601, the graphene thin film 602 may be formed in the form of a single-layered film. When a transition metal thin film is used as the conductive film 601, the graphene thin film 602 may be formed in the form of a multi-layered film. Another example of the various methods is a method of controlling a heat treatment time and/or a heat treatment speed. Another example of the various methods is a method of controlling the concentration of the growth gas. The number of graphene layers of the graphene thin film 602 may be controlled by any one of the methods stated above or a combination of two or more of the methods stated above.

The graphene thin film 602 having the form of a continuous film is formed by processes described above.

[Etching of Conductive Film]

A mask layer 603 having an etching opening 604 for partially exposing the conductive film 601 is formed on other surface of the conductive film 601. The mask layer 603 may be formed of, for example, a polymeric material having corrosion resistance with respect to an etchant corroding metal. The mask layer 603 may be formed by using any one of known methods, such as photolithography, screen printing, and the like.

The mask layer 603 is used as an etching mask, and the conductive film 601 is surface-etched by using an etchant. For example, sulfuric acid, hydrochloric acid, nitric acid, ammonium persulfate, copper ammonium chloride, or the like may be used as the etchant. Thus, as illustrated in FIG. 4C, a portion exposed through the etching opening 604 of the conductive film 601 is corroded and, thus, a penetration portion 605 is formed in the conductive film 601. Since graphene has strong corrosion resistance with respect to most acid solution corroding metals, only the conductive film 601 may be partially removed by the surface etching process, and the graphene thin film 602 remains and is partially exposed through the penetration portion 605.

[Removal of Mask Layer]

When the mask layer 603 is removed by using a solvent, the gate electrode 40 including the graphene sheet 42 supported by the electrode unit 41 may be manufactured as illustrated in FIG. 4D.

The material of the electron emission source 20 is not limited to any specific material. Any one of various materials that are capable of emitting cold electrons by using a gate voltage may be used as the material of the electron emission source 20. For example, carbon nanotube may be used as the material of the electron emission source 20.

The density of electrons that are emitted from the electron emission source 20 is proportional to a voltage applied to the gate electrode 40. As the aspect ratio of the electron emission source 20 is larger, an electric field strengthening effect when an electric field is concentrated on the electron emission source 20 increases, thereby increasing the electron emission density.

By attaching a paste including carbon nanotube to the cathode electrode 10 and attaching and detaching an adhesive tape to and from the paste, the carbon nanotube lying on the surface of the paste may be erected. Thus, the electron emission source 20 having a needle shape with a relatively large aspect ratio may be formed.

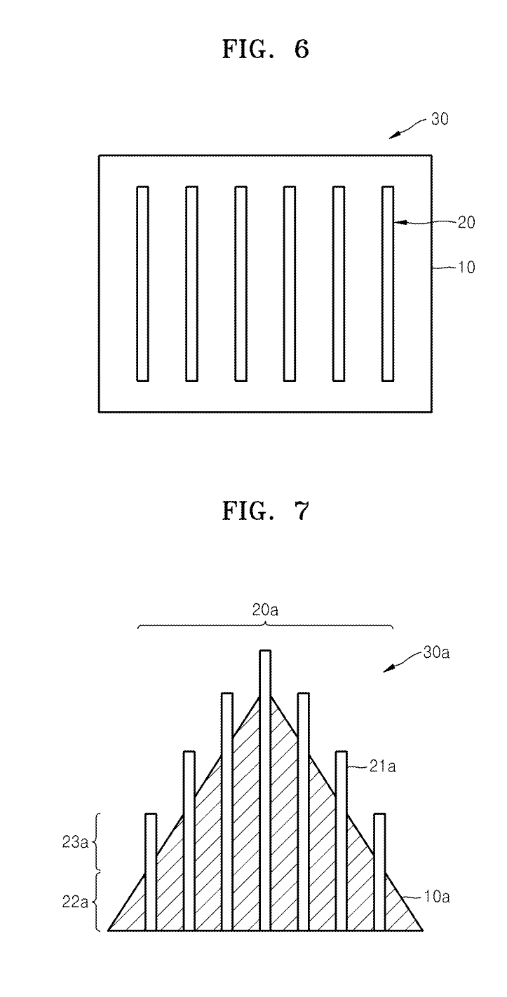

Graphene may be used as the material of the electron emission source 20. FIG. 5 is a cross-sectional view of an emitter 30 according to some example embodiments. FIG. 6 is a plan view of the emitter 30 illustrated in FIG. 5, according to some example embodiments.

Referring to FIGS. 5 and 6, the emitter 30 includes a cathode electrode 10 formed of a conductor and an electron emission source 20 including a plurality of graphene thin films 21 supported by the cathode electrode 10 while standing in the cathode electrode 10 toward the opening 131. Each of the plurality of graphene thin films 21 may be a graphene single-layered film or a graphene multi-layered film. The graphene single-layered film and the graphene multi-layered film each have a thickness T that is only one-atom thickness, which is a few angstroms, through several times through hundred times of one-atom thickness and, thus, a relatively large aspect ratio may be obtained. As a result, a relatively large electric field strengthening effect may be obtained and, thus, a large number of electrons may be easily extracted also under a low gate voltage.

Graphene has a very large electrical conductivity and, thus, contact resistance thereof to the cathode electrode 10 is very small. Also, graphene has excellent heat conductivity. Thus, excellent electrical and thermal interface characteristics between the graphene thin films 21 and the cathode electrode 10 may be obtained, and the degradation of field emission efficiency due to electrical and thermal factors may be prevented.

Referring to FIG. 5, each of the graphene thin films 21 has a vertical form and includes a first portion 22 buried in the cathode electrode 10 and a second portion 23 that extends from the first portion 22 and protrudes from the upper surface of the cathode electrode 10. Due to this configuration, a contact area between the graphene thin films 21 and the cathode electrode 10 may be increased and, thus, a loss in the field emission efficiency due to the electrical and thermal factors may be further reduced.

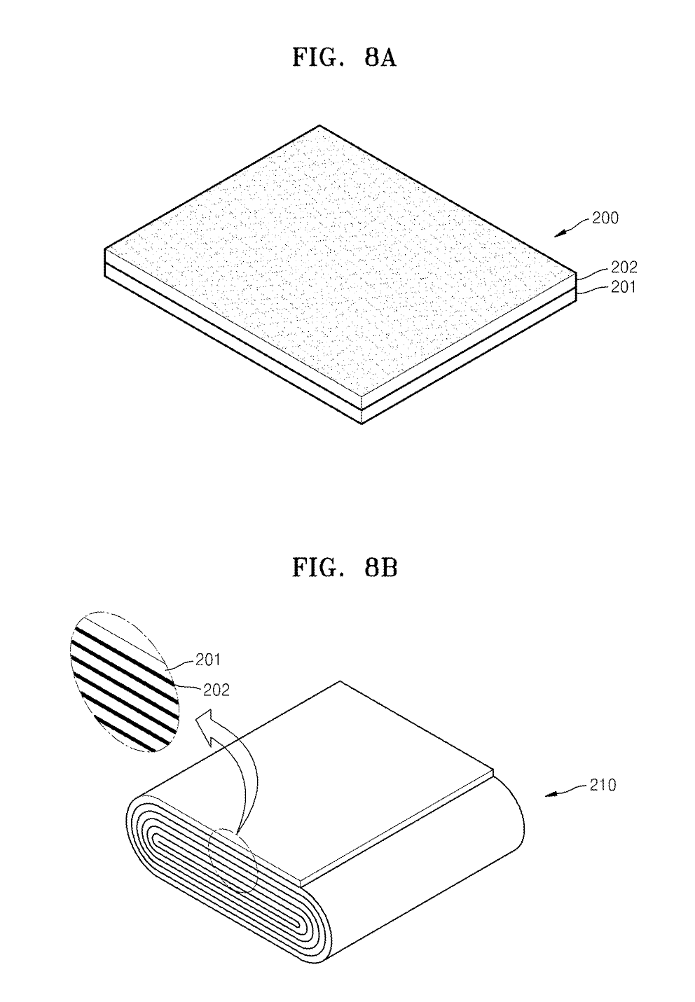

FIG. 7 is a cross-sectional view of an emitter 30a according to some example embodiments.

Referring to FIG. 7, the emitter 30a includes a cathode electrode 10a formed of a conductor and an electron emission source 20a including a plurality of graphene thin films 21a, each of which has a vertical form. Like in the embodiment of FIG. 5, each of the graphene thin films 21a has a vertical form, and includes a first portion 22a buried in the cathode electrode 10a and a second portion 23a that extends from the first portion 22a and protrudes from the upper surface of the cathode electrode 10a. However, the emitter 30a illustrated in FIG. 7 has a pointed shape toward the opening 131. That is, the cathode electrode 10a has a pointed shape toward the opening 131, and the plurality of graphene thin films 21a are disposed in a pointed form toward the opening 131. Due to this form, the electric field strengthening effect may be generally maximized, thereby improving the field emission efficiency.

As would be understood by one of ordinary skill in the art, the shape of emitters according to example embodiments are not limited to that of emitter 30 and emitter 30a. Other emitters may have cathode electrodes with cross-sections that may be, for example, a combination of the rectangular shape of FIG. 5 and the triangular shape of FIG. 7, and/or other geometric shapes. The respective electron emission sources may include a plurality of graphene thin films supported by the cathode electrodes while standing in the cathode electrodes toward respective openings. Each of the plurality of graphene thin films may be a graphene single-layered film or a graphene multi-layered film. The graphene single-layered film and the graphene multi-layered film each may have a thickness that is only one-atom thickness, which is a few angstroms, through several times through hundred times of one-atom thickness and, thus, a relatively large aspect ratio may be obtained. As a result, a relatively large electric field strengthening effect may be obtained and, thus, a large number of electrons may be easily extracted also under a low gate voltage.

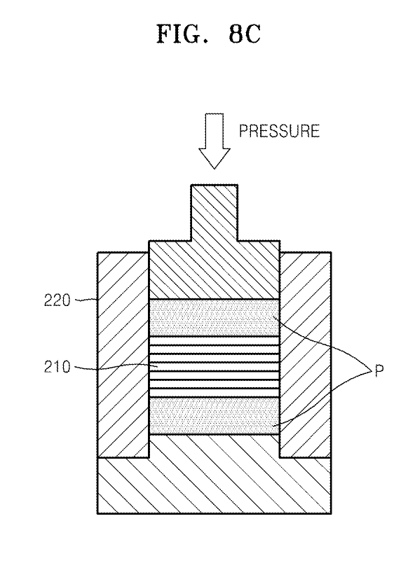

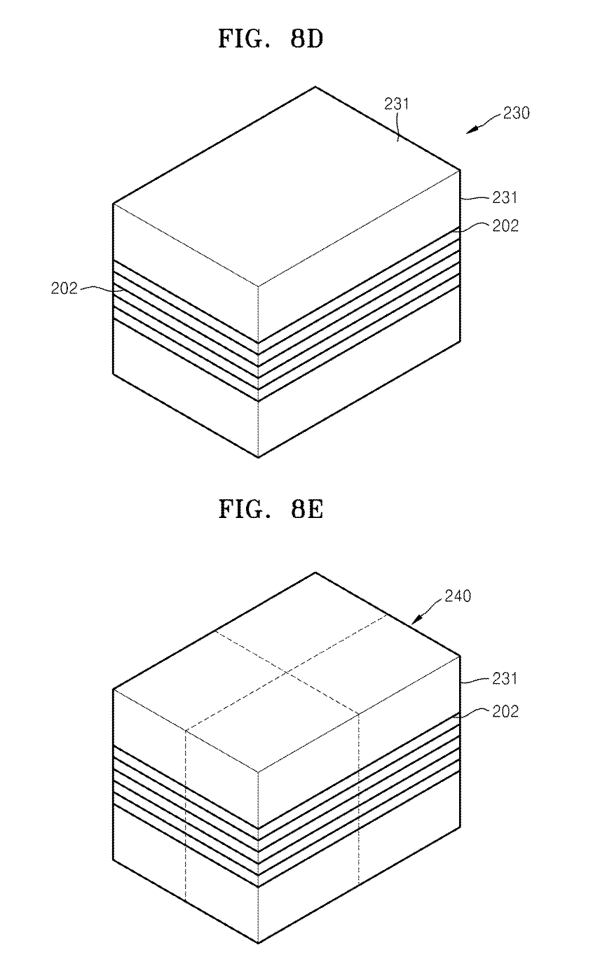

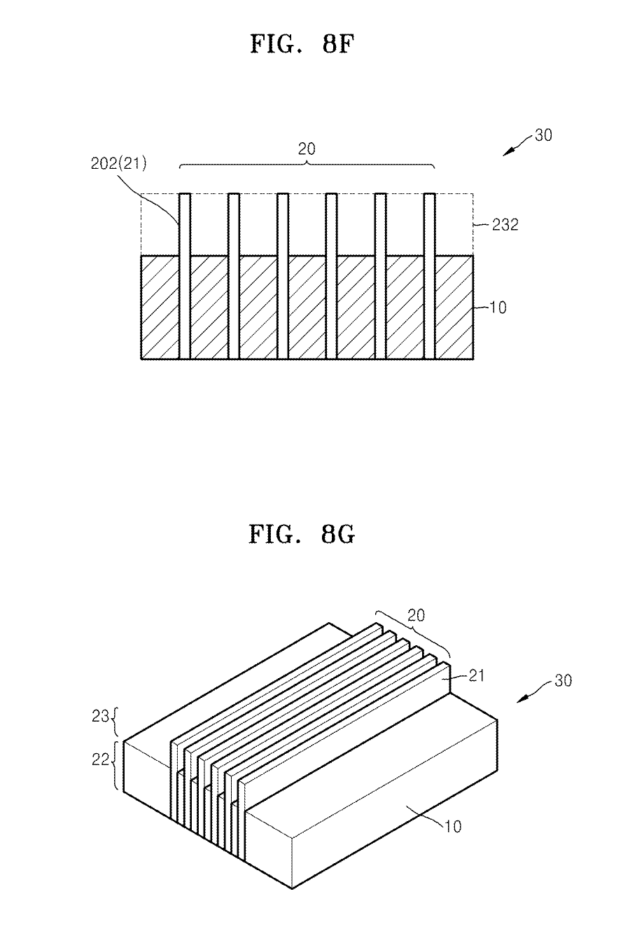

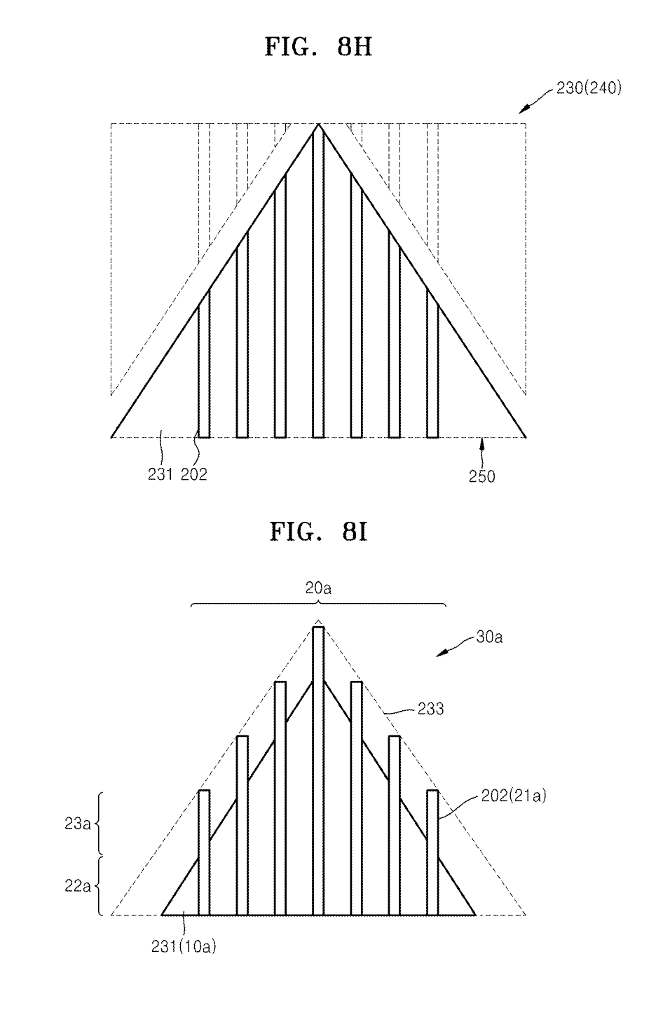

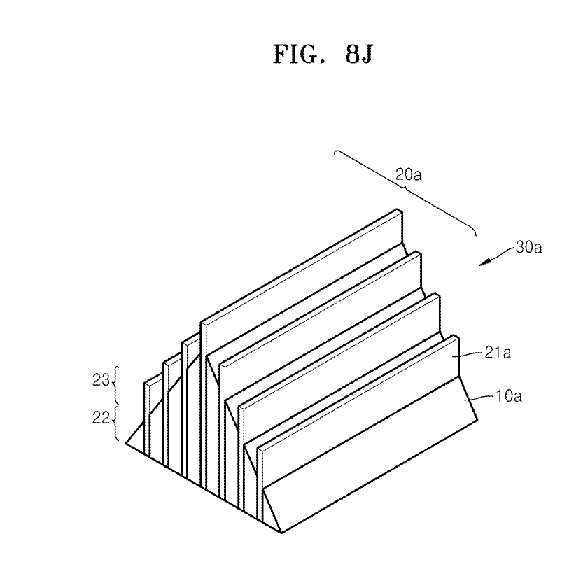

Below, a method of manufacturing the emitter 30 according to some example embodiments is described with reference to FIGS. 8A through 8G.

[Formation of Graphene Sheet]

As illustrated in FIG. 8A, a graphene sheet 200 is formed by forming a graphene thin film 202 on a conductive film 201. A method of forming the graphene thin film 202 is not limited to a specific method, and may use any one of various known methods. For example, the graphene thin film 202 may be formed by growing a graphene atom layer on the conductive film 201 through chemical vapor deposition (CVD). When the CVD is used, a large amount of graphene may be formed in a relatively short time. A metal thin film formed of metal may be used as the conductive film 201. Examples of the metal include copper, nickel, cobalt, iron, platinum, gold, aluminum, chromium, magnesium, manganese, molybdenum, rhodium, silicon, tantalum, titanium, tungsten, etc. Hydrogen and Hydrocarbon (CₓH_{y}) such as methane, ethane, ethylene, ethanol, acetylene, propane, propylene, butane, butadiene, pentane, pentene, cyclopentadiene, hexane, cyclohexane, benzene, toluene, or the like may be used as gas (hereinafter, referred to as “growth gas”) that is used to grow the graphene atom layer. The conductive film 201 and the growth gas are supplied into a reactor (not shown) to treat the conductive film 201 by heating. A heat treatment temperature may be, for example, in the range of about 800° C. to about 1000° C., and a heat treatment time may be, for example, in the range of about 30 minutes to about 2 hours.

The number of graphene layers that are grown may be adjusted by various methods. An example in this regard is a method of controlling the type or thickness of the conductive film 201. For example, when a copper thin film is used as the conductive film 201, the graphene thin film 202 may be formed in the form of a single-layered film. When a transition metal thin film is used as the conductive film 201, the graphene thin film 202 may be formed in the form of a multi-layered film. Another example is a method of controlling a heat treatment time and/or a heat treatment speed. Another example is a method of controlling the concentration of the growth gas. The number of graphene layers of the graphene thin film 202 may be controlled by any one of the methods stated above or a combination of two or more of the methods stated above.

[Formation of Graphene Stack Structure]

As illustrated in FIG. 8B, a graphene stack structure 210 is formed by folding the graphene sheet 200 a number of times. Then, the graphene stack structure 210 has a form in which a plurality of graphene thin films 202 seem to be stacked to be spaced apart from each other by the thickness of the conductive film 201. The number of times that the graphene sheet 200 is folded may be determined in consideration of the number of graphene thin films 21 to be formed in the emitter 30.

[Formation of Sintered Structure]

The graphene stack structure 210 is molded and sintered, together with a conductive powder P. Referring to FIG. 8C, the conductive powder P is filled in a mold 220, and the graphene stack structure 210 is placed on the conductive powder P. In this case, the graphene stack structure 210 is inserted in the mold 220 in a horizontal state. The conductive powder P is filled on the graphene stack structure 210 again. Next, the graphene stack structure 210 is molded together with the conductive powder P by applying pressure thereto through a piston to form a molded structure. Alternatively, after cutting the graphene stack structure 210 to a required size, the cut graphene stack structure may be molded together with the conductive powder P. Next, the molded structure is taken out from the mold 220 and then is sintered at a temperature of about 800° C. to about 1000° C. under vacuum or a reduced atmosphere. Thus, a sintered structure 230 in which the plurality of graphene thin films 202 are stacked to be spaced apart from each other in a conductor 231 may be obtained as illustrated in FIG. 8D. In addition, a defect of graphene that may be caused when forming the plurality of graphene thin films 202 may be reduced through the sintering process. The conductive powder P may be a metal powder including a metal such as copper, nickel, cobalt, iron, platinum, gold, aluminum, chromium, magnesium, manganese, molybdenum, rhodium, silicon, tantalum, titanium, tungsten, or the like. The conductive powder P may be a powder of the same metal as the conductive film 201 so that a fine sintering may be performed through the sintering process.

[Cutting]

When necessary, as illustrated in FIG. 8E, a cut structure 240 may be formed by cutting the sintered structure 230 to an appropriate size.

[Formation of Electron Emission Source]

Next, as illustrated in FIG. 8F, a portion 232 of the conductor 231 is removed from the sintered structure 230 or the cut structure 240 in the length direction of the graphene thin films 202 to expose the graphene thin films 202. Thus, the graphene thin films 202 are exposed from the conductor 231 while having a vertical form. Removing the portion 232 of the conductor 231 may be performed by a surface etching process using an etchant that selectively corrodes the conductor 231. For example, sulfuric acid, hydrochloric acid, nitric acid, ammonium persulfate, copper ammonium chloride, or the like may be used as the etchant. Since graphene has strong corrosion resistance with respect to most acid solution corroding metals, only the portion 232 of the conductor 231 may be removed by the surface etching process.

Through the processes described above, the emitter 30, which includes a cathode electrode 10 and an electron emission source 20 including the graphene thin films 21, may be formed as illustrated in FIGS. 8F and 8G. Each of the graphene thin films 21 has a vertical form, and includes a first portion 22 buried in the cathode electrode 10 and a second portion 23 that protrudes from the upper surface of the cathode electrode 10.

The pointed-shaped emitter 30a illustrated in FIG. 7 may be manufactured by using the following method.

[Formation of Spire-Shaped Structure]

First, the processes described with reference to FIGS. 8A through 8D (or 8E) are performed. Next, after standing the sintered structure 230 or the cut structure 240 in the direction of the lengths of the graphene thin films 202, the sintered structure 230 or the cut structure 240 is slantingly cut with respect to the direction of the lengths. Thus, as illustrated in FIG. 8H, a spire-shaped structure 250, which includes the graphene thin films 202 stacked to be spaced apart from each other in a conductor 231, in which one end of each of the graphene thin films 202 in the direction of the lengths is pointed, is formed.

[Formation of Electron Emission Source]

As illustrated in FIG. 8I, a portion 233 of the conductor 231 is removed from the spire-shaped structure 250 in the direction of the lengths of the graphene thin films 202 to expose the graphene thin films 202. Thus, the graphene thin films 202 are exposed from the conductor 231 while having a vertical form. Removing the portion 233 of the conductor 231 may be performed by a surface etching process using an etchant that selectively corrodes the conductor 231. For example, sulfuric acid, hydrochloric acid, nitric acid, ammonium persulfate, copper ammonium chloride, or the like may be used as the etchant. Since graphene has strong corrosion resistance with respect to most acid solution corroding metal, only the portion 233 of the conductor 231 may be removed by the surface etching process.

Through the processes described above, the emitter 30a, which includes a cathode electrode 10a and an electron emission source 20a including graphene thin films 21 and has a pointed shape, may be formed as illustrated in FIGS. 8I and 8J. Each of the graphene thin films 21a has a vertical form and includes a first portion 22a buried in the cathode electrode 10a and a second portion 23a that protrudes from the upper surface of the cathode electrode 10a.

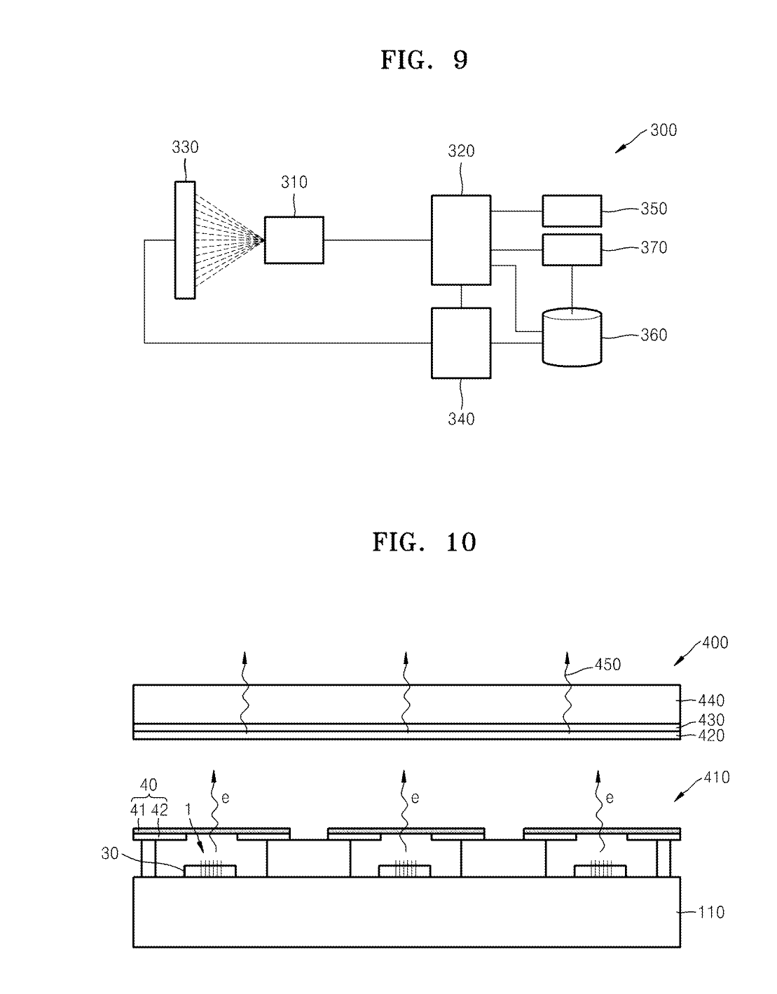

The field emission device 1 described above may be applied to various electronic apparatuses. FIG. 9 is a schematic block diagram of an X-ray imaging device 300 using the field emission device 1 illustrated in FIG. 1, according to some example embodiments. Referring to FIG. 9, the X-ray imaging device 300 according to the current embodiment may include an X-ray emission device 310, a controller 320 for controlling the X-ray emission device 310, an imaging unit 330 for capturing an image from X-rays that passes through a target object after being emitted from the X-ray emission device 310, an image processor 340 for processing information about images captured by the imaging unit 330, an input unit 350 for inputting a user's operation, an output unit 370 for outputting image-processed information, and a data storage unit 360 for storing various pieces of information including the information about images. As described above, when an anode electrode formed of a metal, such as Mo, Ag, W, Cr, Fe, Co, Cu, or the like, or a metal alloy is employed as the anode electrode 2 in FIG. 1, the X-ray emission device 310 for emitting X-rays may be implemented. Elements other than the X-ray emission device 310 are publicly known elements and, thus, detailed descriptions thereof are omitted.

FIG. 10 is a diagram illustrating a back light device 400 (display device) according to some example embodiments. Referring to FIG. 10, an anode electrode layer 420, a fluorescent layer 430, and a transparent substrate 440 are disposed above an electron emission device 410 in which a plurality of field emission devices 1 as illustrated in FIG. 1 are arranged. Electrons “e” emitted from the electron emission device 410 pass through the anode electrode layer 420 and reach the fluorescent layer 430. The fluorescent layer 430 is formed of a cathode luminescence (CL)-typed fluorescent material that is excited by the electrons “e” to generate visible light 450. Thus, the electrons “e” are converted into the visible light 450 when colliding with the fluorescent layer 430. The position of the anode electrode layer 420 and the position of the fluorescent layer 430 may be reversed.

The back light device 400 (display device) may be used as a backlight unit (BLU) of a display device, such as a liquid crystal display (LCD), which is not capable of autonomously emitting light, or a backlight unit of a lighting apparatus. Also, the back light device 400 (display device) itself may be used as an image display device. For example, when all of the emitters 30 of the electron emission device 410 are driven together, the back light device 400 (display device) may be used as a back light unit of a display device or a lighting apparatus. When the emitters 30 of the electron emission device 410 form a pixel array in which the emitters 30 are independently driven for each pixel, the back light device 400 (display device) itself may become a display device displaying an image.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A field emission device, comprising:
an emitter comprising a cathode electrode and an electron emission source supported by the cathode electrode;
an insulating spacer around the emitter, the insulating spacer forming an opening that is a path of electrons emitted from the electron emission source; and
a gate electrode comprising a graphene sheet covering the opening.

2. The field emission device of claim 1, wherein the gate electrode further comprises an electrode unit around the opening, and
wherein the graphene sheet is connected to the electrode unit.

3. The field emission device of claim 1, wherein the graphene sheet is a graphene single-layered film or a graphene multi-layered film.

4. A field emission device, comprising:
an emitter comprising a cathode electrode and an electron emission source supported by the cathode electrode;
an insulating spacer around the emitter; and
a gate electrode, supported by the insulating spacer, comprising an electrode unit that defines an opening that is a discharge path of electrons emitted from the emitter, and a tunneling member that covers the opening and passes the electrons therethrough according to a tunneling effect.

5. The field emission device of claim 4, wherein the tunneling member comprises a graphene-continuous film.

6. The field emission device of claim 5, wherein the graphene-continuous film is connected to the electrode unit.

7. The field emission device of claim 5, wherein the graphene-continuous film is a graphene single-layered film or a graphene multi-layered film.

8. The field emission device of claim 1, wherein the electron emission source comprises a plurality of graphene thin films vertically supported in the cathode electrode.

9. The field emission device of claim 8, wherein each of the plurality of graphene thin films comprises:
a first portion buried in the cathode electrode; and
a second portion that extends from the first portion and is exposed from the cathode electrode.

10. The field emission device of claim 8, wherein the cathode electrode has a pointed shape toward the opening, and
wherein the plurality of graphene thin films are in a pointed structure toward the opening.

11. The field emission device of claim 8, wherein each of the plurality of graphene thin films is a graphene single-layered film or a graphene multi-layered film.

12. A method of manufacturing a gate electrode, the method comprising:
forming a graphene thin film on one surface of a conductive film;
forming a mask layer having an etching opening on another surface of the conductive film, wherein the etching opening exposes a portion of the conductive film;
partially removing the conductive film through the etching opening to partially expose the graphene thin film; and
removing the mask layer.

13. The method of claim 12, wherein the graphene thin film is a graphene-continuous film.

14. The method of claim 12, wherein the graphene thin film is a graphene single-layered film or a graphene multi-layered film.
